(19) United States
(12) Patent Application Publication
(10) Pub. No.: US 2016/0016200 A1
(43) Pub. Date: Jan. 21, 2016

(54) PNEUMATIC PRODUCT SORTING APPARATUS

(71) Applicant: MATRIX S.P.A., Ivrea (IT)

(72) Inventors: Mario Gaiardo, Ivrea (IT); Massimo Menaldo, Torrazzo (IT)

(21) Appl. No.: 14/766,159

(22) PCT Filed: Feb. 25, 2014
(86) PCT No.: PCT/IB2014/059243

§ 371 Date: Aug. 6, 2015

(30) Foreign Application Priority Data
Feb. 25, 2013 (IT) TO2013A000154

(51) Int. Cl. B07B 4/02

(52) U.S. Cl. CPC B07B 4/02

(57) ABSTRACT

Pneumatic product sorting apparatus includes at least one solenoid valve having a hollow body defining at least one inlet orifice for a pressurized fluid, a plurality of outlet orifices, and a plurality of conveying channels for conveying the fluid from the inlet orifice to the respective outlet orifices. The apparatus further includes at least one ejection head having a plurality of firing nozzles that are selectively operable for emitting respective pressurized fluid jets directly on products to be selected; and a plurality of connecting conduits connecting each firing nozzle to a corresponding outlet orifice of said solenoid valve. The ejection head is formed by a cover of the body of the solenoid valve and the connecting conduits are obtained in the aforesaid cover.

### TECHNICAL FIELD

The present invention relates to a pneumatic product sorting apparatus by attributes (color, quality, size, weight, etc.), in particular foodstuff, to be divided according to size or other features, for example grains, such as rice, wheat and seeds in general, to which explicit reference will be made in the following description without because of this loosing in generality.

### BACKGROUND ART

Apparatuses of the type described above are known, which are arranged so as to interact with the channels on which the products to be selected travel and act on such products by generating, when needed, very accurate jets of pressurized fluid, usually air, to move the undesired elements away from said channels.

The known apparatuses substantially comprise:
a solenoid valve provided with a hollow body which has an inlet orifice of the pressurized fluid and a plurality of outlet orifices of the fluid itself, and internally accommodates a plurality of interception elements, which can be selectively operable to either prevent or allow the passage of fluid through the respective outlet orifices;
an ejection head having a plurality of firing nozzles that can be selectively operable to emit respective pressurized fluid jets directly onto products to be selected; and
a plurality of tubes connecting each firing nozzle to a corresponding outlet orifice of the solenoid valve.

The solenoid valve further internally comprises a plurality of actuators of the electromagnetic type to control the aforesaid interception elements.

In particular, each interception element generally consists of a ferromagnetic material keeper or plate provided on a face thereof which a shutter, e.g. a disc made of elastomeric material, adapted to fluid-tightly cooperate with the corresponding outlet orifice; each interception element can be displaced between a first configuration, in which the shutter fluid-tightly cooperates with the respective outlet orifice, preventing the fluid from crossing it and a second configuration, in which the shutter is arranged in a position spaced from the respective outlet orifice allowing the passage of fluid through the orifice itself.

The various interception elements are equally spaced angularly about a central axis of the body of the solenoid valve.

The various interception elements are elastically loaded towards the first fluid-tightly closed configuration of the outlet orifices by an annular element made of elastically yielding material.

Each electromagnetic actuator substantially comprises an electromagnet housed in the body of the solenoid valve which can be selectively operable to attract the respective interception element so as to move it into the second configuration.

Typically, the ejection head is arranged in position adjacent to the channel along which the products to be selected are conveyed, so as to act directly and efficiently on the products which, according to predetermined requirements (size, weight, type etc.) must be removed from the moving mass. The solenoid valve, which is usually large, is instead generally arranged in remote position with respect to the ejection head and the outlet orifices of the solenoid valve itself are thus connected to the firing nozzles of the ejection head by means of tubes of considerable length.

Although being functionally valid, the described solution is susceptible to improvements in particular in terms of efficiency and response rapidity of the system to the activation controls of the electromagnetic actuators.

Indeed, it is apparent that the time which elapses between the instant of activation of an actuator and the instant in which the jet of pressurized fluid actually exits from the respective firing nozzle depends on the length of the respective connection tube. Furthermore, if such a length is not the same for all the tubes, the response times of the system are different from one firing nozzle to another.

It is further worth noting that the number of pneumatic connections needed to allow the flow of pressurized fluid from the inlet orifice of the solenoid valve to the firing nozzles determines a non-negligible risk of pneumatic leakage with consequent reduction of system efficiency.

Furthermore, the risk of breakage of the tubes and/or of contamination of the system during assembly and/or maintenance of the latter are relatively high.

Indeed, the technological developments of sorting apparatus over time is requiring firing nozzles capable of operating at increasingly higher working frequencies.

These high frequencies generate the need to use low ohmic value windings in the electromagnetic actuators, which, in combination with suitable operating strategies (thus with high current draws) require solenoid valves with high thermal dissipation capacities, currently not very satisfactory.

### DISCLOSURE OF INVENTION

It is thus the object of the present invention to make a pneumatic product sorting apparatus, which allows to solve at least one of the drawbacks connected to the sorting apparatuses of known type described above in simple and cost-effective manner.

The aforesaid object is reached by the present invention in that is relates to a pneumatic product sorting apparatus as defined in claim 1.

### BRIEF DESCRIPTION OF THE DRAWINGS

For a better understanding of the present invention, some preferred embodiments will be described hereinafter by way of non-limiting example only, and with reference to the accompanying drawings, in which:

FIG. 1 is a partially exploded perspective view of the pneumatic product sorting apparatus made according to the dictates of the present invention;

FIG. 2 is a perspective partially exploded view of an operating unit of the apparatus in FIG. 1;

FIG. 3 is a section view on enlarged scale and with parts removed for clarity taken along the line III-III in FIG. 2;

FIG. 3A is a section similar to the section in FIG. 3 showing a possible variant of the operating unit in FIG. 2;

FIG. 4 shows a top view on enlarged scale of a detail of the operating unit in FIG. 2;

FIG. 5 is an enlarged section view taken along line V-V in FIG. 4;

FIG. 6 is a figure similar to FIG. 4 showing a possible variant of the operating unit in FIG. 2;

FIG. 7 is a figure similar to FIG. 2 showing another possible variant of the operating unit in FIG. 2;

FIG. 8 is a section similar to the section in FIG. 3 showing, with parts removed for clarity, the variant of the operating unit in FIG. 7; and

FIG. 9 shows a partially exploded view of a different embodiment of a pneumatic product sorting apparatus made according to the dictates of the present invention.

### BEST MODE FOR CARRYING OUT THE INVENTION

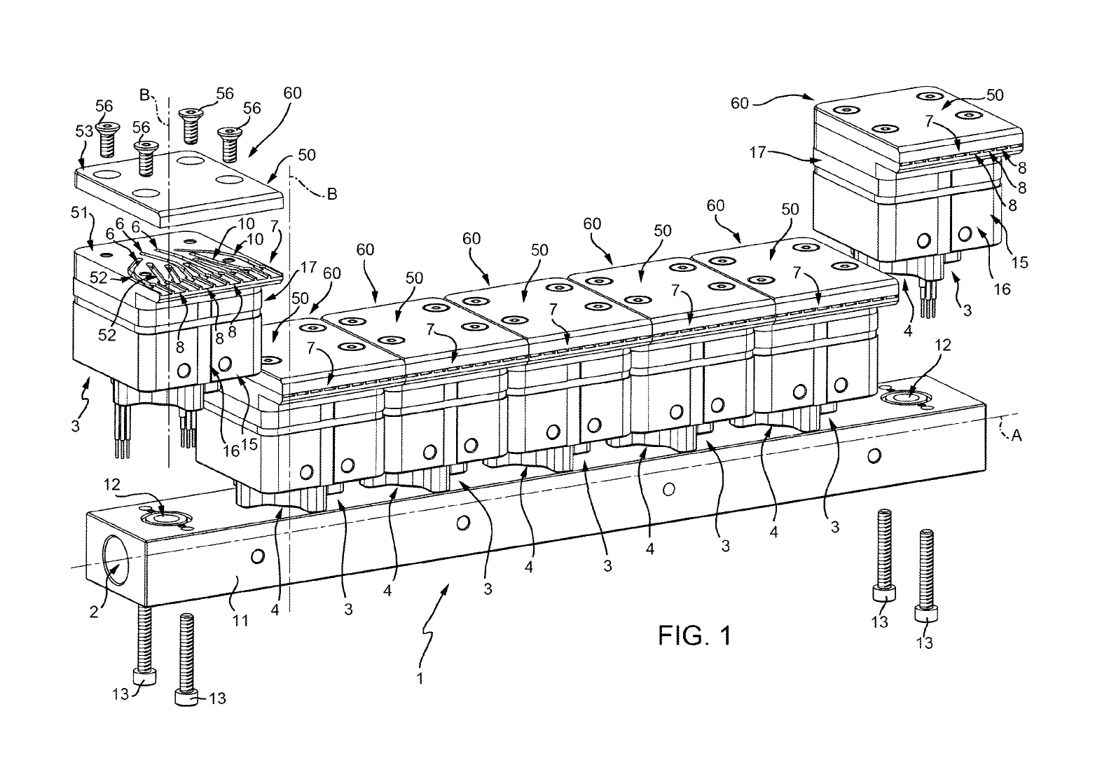

With reference to FIG. 1, numeral 1 indicates as a whole an apparatus for pneumatic sorting of products, in particular foodstuff, such as for example grains, such as rice, wheat and seeds in general (known in themselves and not shown) according to the present invention.

The apparatus 1 is known and adapted to be arranged by the side of a selection channel (also known in itself and not shown) along which the material to be sorted advances.

The apparatus 1 substantially comprises:
a supplying manifold 2 of a pressurized fluid, for example air;
a plurality of solenoid valves 3, each of which is connected at an inlet orifice 4 thereof to the manifold 2 and defines a plurality of conveying channels 5, nine in the illustrated case in point, which can be selectively opened to direct the pressurized fluid towards respective outlet orifices 6, the number of which is equal to that of the conveying channels 5;
a plurality of ejection heads 7, each of which is provided with a plurality of firing nozzles 8 to emit respective jets of pressurized fluid directly onto the products to be selected; and
a plurality of connecting conduits 10 for connecting the nozzles 8 of each ejection head 7 to respective outlet orifices 6 of a corresponding solenoid valve 3.

As shown in FIG. 1, the manifold 2 is formed through a base bar 11 of the apparatus 1 and extends along a longitudinal axis A. In particular, the bar 11 is provided, along a face thereof arranged on top in FIG. 1, with a plurality of outlet holes 12 extending orthogonally to the manifold 2 and connecting the inlet orifices 4 to the respective solenoid valves 3 in use. In practice, each solenoid valve 3 is mounted on the bar 11 so as to be supported by the latter and fixed to the bar 11 itself by means of screws 13.

With reference to figures from 1 to 3, each solenoid valve 3 is delimited by a body 15 made of non-magnetic material, e.g. a light metal alloy, which preferably has a quadrangular section, e.g. a square section, and substantially comprises two different structures 16 and 17 assembled to each other and defining the inlet orifice 4 and the conveying channels 5, respectively. Each solenoid valve 3 further comprises a fluidic interception group 18 to open/close the fluidic connection between the inlet orifice 4 and the conveying channels 5, and thus the outlet orifices 6, independently and an actuator assembly 19 of the electromagnetic type to control the fluidic interception assembly 18.

The solenoid valves 3 are mutually identical and for this reason only one will be described hereinafter it being understood that the same features of such a solenoid valve are present also in the other solenoid valves 3.

The structure 16 of solenoid valve 3 has a parallelepiped cup-shaped configuration and centrally carries the inlet orifice 4 for the pressurized fluid. In particular, the inlet orifice 4 has an axis B orthogonal to axis A and coaxial to the respective outlet orifice 12 of the bar 11. Axis B further defines a main axis of the solenoid valve 3.

The structure 16 has a bottom wall 16a, which is orthogonal to axis B, from which the inlet orifice 4 extends, and a parallelepiped side wall 16b which protrudes orthogonally and cantilevered from the bottom wall 16a; the bottom 16a and side 16b walls delimit a compartment 20, which communicates with the inlet orifice 4, the function of which will be explained below.

The structure 17 is closingly coupled in use to the structure 16 from the side opposite to the one from which the inlet orifice 4 extends. The structure 17 consists of a plate 21, which extends orthogonally to axis B of the inlet orifice 4 and defines a plurality of conveying channels 5 for the passage of pressurized fluid, nine in the illustrated case in point.

The conveying channels 5 are equal to one another, have respective axes parallel to axis B of the inlet orifice 4 and are arranged on a circumference C coaxial to axis B itself; the conveying channels 5 further extend in angularly equally spaced positions about axis B.

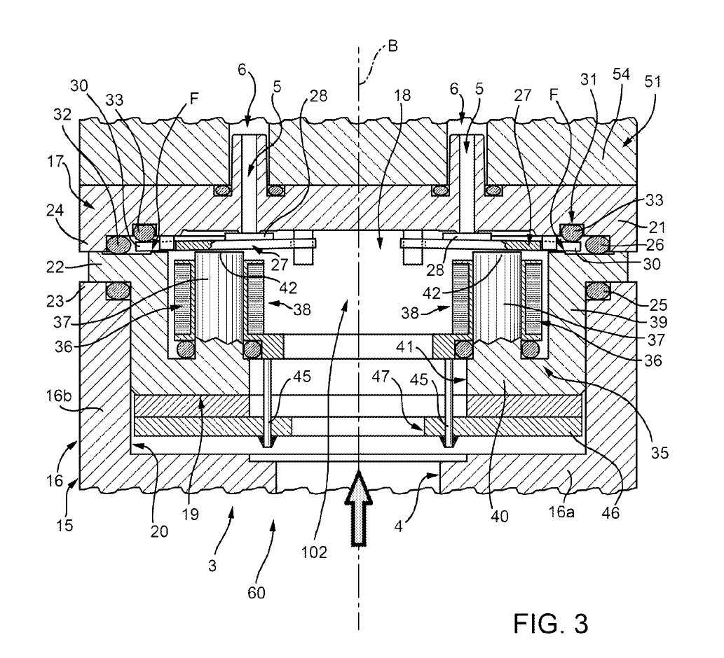

With reference to FIG. 3, the fluidic interception assembly 18 acts directly on the conveying channels 5 and is positioned on the side of the plate 21 of the structure 17 facing the structure 16, while the actuator assembly 19 is accommodated in the compartment 20 of the structure 16 and has an external flange 22 clamped in use between an end edge 23 of the wall 16a of the structure 16, opposite to the inlet orifice 4, and a peripheral edge 24 of the plate 21 of the structure 17 protruding outwards.

Respective annular seals 25, 26 cooperating on opposite sides with the flange 22 of the actuator assembly 19 are provided on both edges 23 and 24.

The fluidic interception assembly 18 comprises a plurality of interception elements 27 operating on respective conveying channels 5 on the side of which the latter lead into the compartment 20 of the structure 16.

Each interception element 27 consists of a plate made of ferromagnetic material extending substantially parallel to the plate 21 and interposed between the latter and the actuator assembly 19. The various interception elements 27 are thus substantially coplanar to each other and are arranged as a dial about axis B.

More precisely, each interception element 27 is arranged in interposed position between the inlet orifice 4 and the respective conveying channel 5 and extends transversally to one another.

Each interception element 27 can be moved between a closed configuration and an open configuration of the respective conveying channel 5; in particular, in the closed configuration, the interception element 27 interferes with the respective conveying channel 5 to prevent the flow of pressurized fluid from the inlet orifice 4 from, crossing the conveying channel 5 itself and from reaching the respective outlet orifice 6, the respective connecting conduit 10 and the respective firing nozzle 8 from there; in the open configuration, instead, the interception element 27 leaves the respective conveying channel 5 free to allow the flow of pressurized fluid from the inlet orifice 4 to cross the conveying channel 5 itself and to reach the respective outlet orifice 6, the respective connecting conduit 10 and the respective firing nozzle 8 from there.

Each interception element 27 is provided along a face thereof facing the plate 21, with a shutter 28 made of elastomeric material, e.g. a silicone rubber disc, adapted to engage the mouth of the corresponding conveying channel 5 to fluid-tightly close it.

As shown in FIG. 3, the shutter 28 is arranged angularly equally spaced by a predetermined amount which is other than zero on each interception element 27 from a respective end portion 30 of the interception element 27 itself, arranged adjacent to the edges 23 and 24 of the wall 16a and of the plate 21, respectively.

The interception elements 27 are normally pushed into the closed configuration by elastic means 31 and which can be selectively moved into the open configuration by activating the actuator assembly 19 against the bias of such elastic means 31.

Preferably, the elastic means 31 comprise an annular element 32 made of yielding elastic materials, e.g. made of elastomeric material, accommodated coaxially to axis B within a respective annular groove obtained in the plate 21 of the structure 17 near the peripheral edge 24. In particular, the annular element 32 has, in the illustrated example, a circular section and cooperates in contact at interaction portions 33 thereof, with respective end portions 30 of the interception elements 27. Each interception element 27 has a fulcrum zone (FIG. 3), shown as a whole by reference F and described in greater detail below in position immediately adjacent to the interaction zone with the annular element 32. In practice, under the bias of the interaction portions 33 of the annular element 32, the corresponding interception elements 27 are slightly turned about the respective fulcrums F in the closed configurations and may turn in the opposite direction under the action of the actuator assembly 19 towards the open configurations. The interaction portions 33 of the annular element 32 are angularly equally spaced apart about axis B.

In the closed configuration, the elastic load exerted by each interaction portion 33 of the annular element 32 on the respective interception element 27 maintains such an element with the shutter 28 pressed against the mouth of the respective conveying channel 5; in the open configuration, instead, each interception element 27 has the shutter 28 thereof spaced from the respective conveying channel 5 so as to allow the pressurized fluid to cross it.

The actuator assembly 19 comprises a core 35 made of ferromagnetic material and a plurality of electric windings 36, the number of which is equal to the number of the interception elements 27, wound on respective cylindrical portions 37 of the core 35 and which can be selectively energized to move each interception element 27 from the closed configuration to the open configuration in independent manner. In practice, the cylindrical portions 37 of the core 35 define respective electromagnets 38 associated to the respective conveying channels 5, and thus to the respective outlet orifices 6, to the connecting conduits 10, together with the corresponding windings 36.

In particular, the core 35 is substantially shaped as a perforated cylindrical cup and is coaxially engaged to axis B in the compartment 20 of the structure 16. More specifically, the core 35 comprises a substantially cylindrical side wall 39 of axis B ending with a flange 22 on one axial end and an annular disc-shaped base wall extending orthogonally to axis B starting from an axial end opposite to the side wall 39 and having central hole 41 communicating with the inlet orifice 4; the cylindrical portions 37 extend orthogonally cantilevered from the base wall 40 inside the side wall 39, have axes parallel to the axis B and are arranged at the respective interception elements 27. In greater detail, the cylindrical portions 37 are arranged angularly equally spaced about axis B and have respective free axial ends 42 adjacent to the corresponding interception elements 27.

Preferably, a layer of non-magnetic material (not shown in FIG. 3) is fixed on each flat shaped axis end 42, consisting, for example, of a sheet of plastic or non-magnetic metal, in order to create a minimum air gap in the magnetic circuit of the respective electromagnet 38.

A slightly raised portion is provided on the radially inner end edge of the side wall 39 of the core 35 on which the various interception elements 27 rest defining the respective fulcrums F.

As previously mentioned, the core 35 is nearly entirely accommodated within the compartment 20 of the structure 16, except for the flange 22, which is axially pinched in use between the end edge 23 of the structure 16 and the peripheral, edge 24 of the plate 21 of the structure 17.

In known manner, each winding 36 has a pair of terminals 45 (only one of which is shown in FIG. 3) welded onto a printed circuit 46 accommodated on the bottom of the compartment 20 between the inlet orifice 4 and the core 35, and having a central hole 47 for the passage of pressurized fluid coming from the inlet orifice 4 itself.

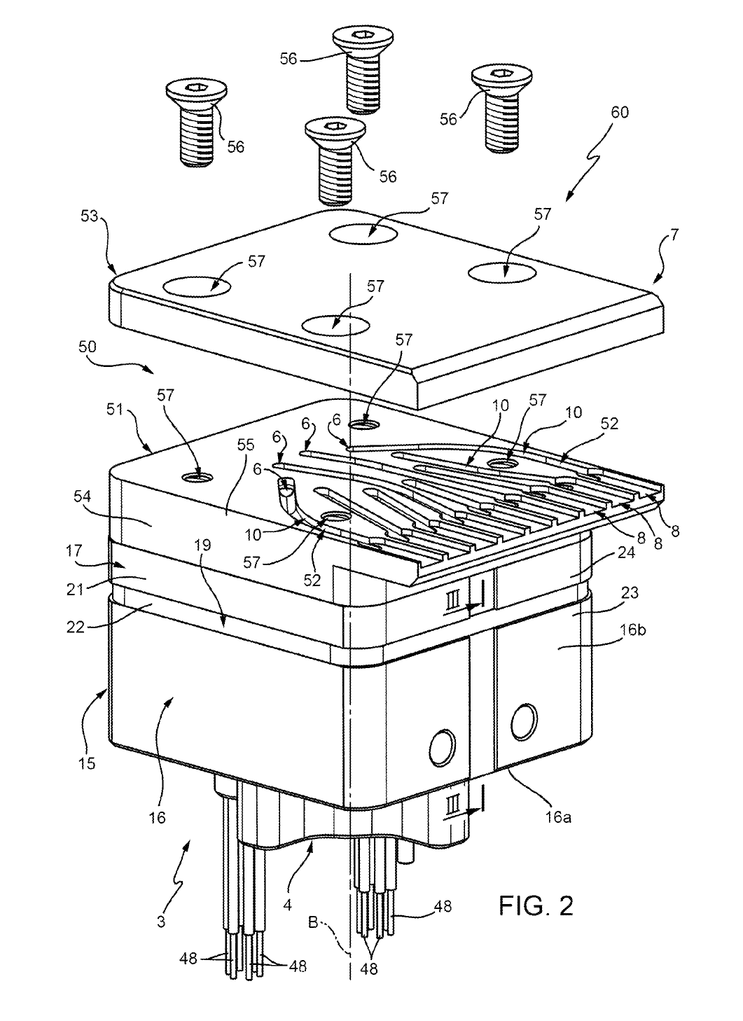

A plurality of pairs of electric conductors 48 (FIGS. 1 and 2) for supplying the windings 36 is further connected by means of the printed circuit 46, to the pairs of terminals 45 of the windings 36 themselves. The wires 48 are collected in two bundles which exit from the bottom wall 16a of the structure 16 through respective through holes (not shown in the accompanying figures).

As shown in FIG. 3, the holes 41 and 47 and the windings 36 delimit a flow channel 102 of the pressurized fluid, extending through the compartment of the body 15 from the inlet orifice 4 to the outlet orifices 6. In this manner, the windings 36 are touched by the flow of pressurized fluid entering from the inlet orifice 4 and directed towards the outlet orifices 6. In this manner, the pressurized flow of fluid performs a ventilation and cooling action of the windings 36.

The variant in FIG. 3A shows a solution adapted to boost the ventilation and cooling action of the windings 36 performed by the pressurized fluid through the body 15.

In particular, in this case, the body 15 internally defines a secondary branch 101, which originates from the flow channel 102 and is configured so as to convey part of the pressurized fluid, entering through the inlet orifice 4, towards the part of the outer surfaces of the windings 36 opposite to that delimiting the flow channel 102 itself.

More specifically, in the solution in FIG. 3A, the core 35 and the printed circuit 46 are accommodated in the side wall 16b of the structure 16 with radial clearance with respect to axis B so as to form an annular portion 103 of the secondary branch 101; the remaining part of the secondary branch 101 consists of an axial gap 104, obtained between the bottom wall 16a of the structure 16 and the printed circuit 46 and communicating laterally with the flow channel 102.

The side wall 39 of the core 35 is further provided with a plurality of radial through holes 100, adapted to put the annular portion 103 of the secondary branch 101 into communication with the compartment accommodating the windings 36. Advantageously (figures from 1 to 4), each ejection head 7 is formed by a cover 50 of the body 15 of a respective solenoid valve 3, and the respective connecting conduits 10 are obtained directly in the aforesaid cover 50. In practice, each ejection head 7 is integrated in the body 15 of a respective solenoid valve 3, thus making the apparatus 1 particularly compact and capable of ensuring particularly short, and practically immediate, response times when the interception elements 27 are activated to be taken to the open configuration.

Because the covers 50 of the various solenoid valves 3 are entirely identical to one another, only one will be described hereinafter, it being understood that the same features of such a cover are also present in the covers 50 of the other solenoid valves 3.

With reference to figures from 1 to 3, the cover 50 comprises:
a first plate 51 supporting the outlet orifices 6 and the firing nozzles 8 and provided with a plurality of grooves 52 connecting the outlet orifices 6 to the respective firing, nozzles 8; and
a second plate 53 fixed superimposed on the plate 51 and delimiting the connecting conduits 10 with the grooves 52.

In particular, the plate 51 comprises a first portion 54 which is perfectly superimposed and aligned with the plate 21 in use, and a second portion 55 cooperating with the plate 53 in use and protruding from one side with respect to the portion 54.

In greater detail, the outlet orifices 6, all equal to one another, extend through both portions 54 and 55 of the plate 51 and communicate with the respective conveying channels 5. The arrangement of the outlet orifices 6 is similar to that of the conveying channels 5, i.e. they are arranged on a circumference C coaxial to axis B. In the illustrated case in point, the outlet orifices 6 are coaxial with the respective conveying channels 5 and extend in positions angularly equally spaced apart about axis B.

The plate 53 closes the top of the outlet orifices 6.

The portion 55 of the plate 51 carries both the firing nozzles 8 and the grooves 52. In particular, the firing nozzles 8 consist of openings obtained along the protruding side of the portion 55 of the plate 51; in practice, the firing nozzles 8 are obtained on a side surface of the portion 55 of the plate 51. The grooves 52 obtained, instead, for example, by way of milling on the surface of the portion 55 of the plate 51 intended to cooperate with the plate 53 in use and thus extend transversally to the conveying channels 5 and the outlet orifices 6. The grooves 52 are closed on top by the plate 53, thus becoming in practice holes in the cover 50, defining the respective connecting conduits 10 in turn.

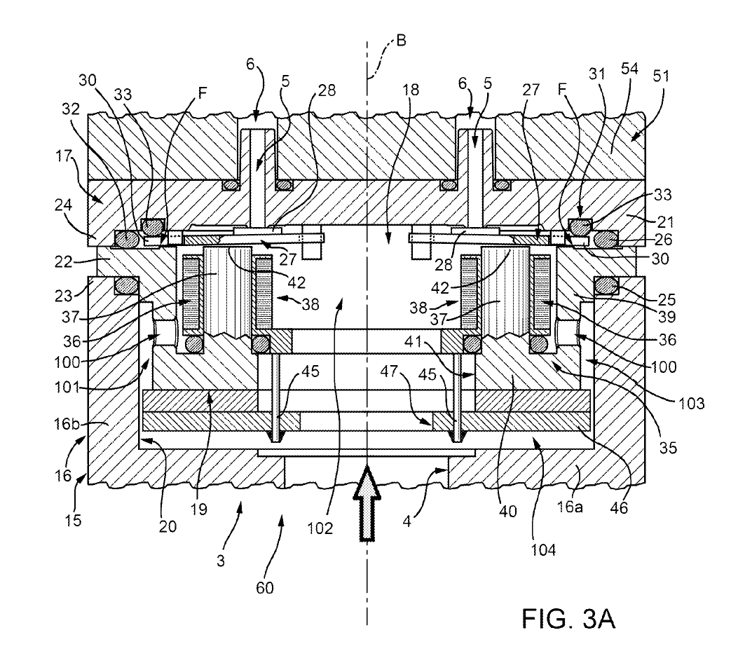

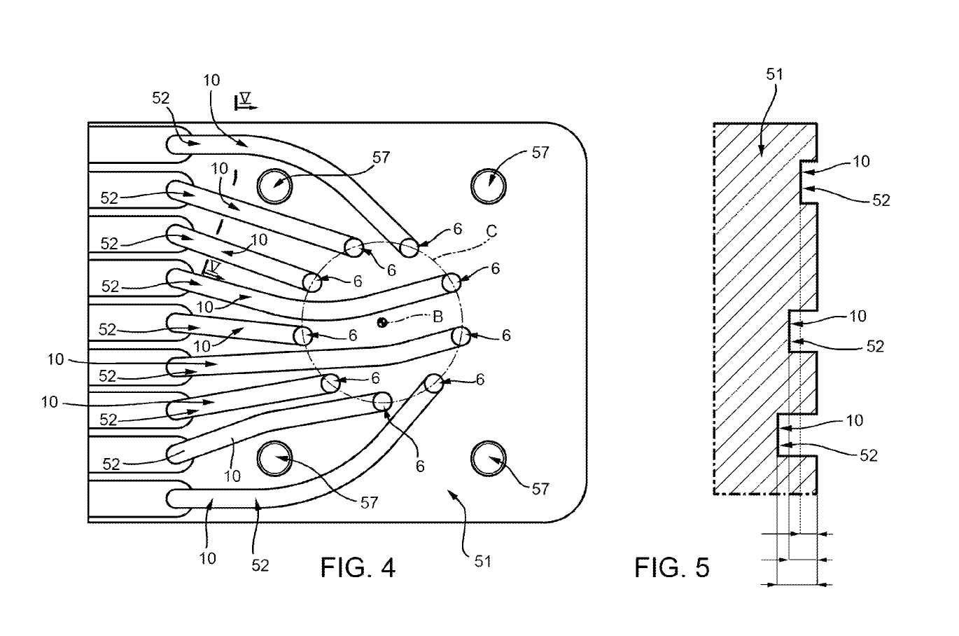

With particular reference to FIGS. 4 and 5, in general the connecting conduits 10 have mutually different lengths given the arrangement of the outlet orifices 6.

Advantageously, the connecting conduits 10 have the same volume as the outlet orifices 6 of the solenoid valve 3 with respect to the firing nozzles 8. In other words, considering any two connecting conduits 10 of different lengths, the cross section of the longest connecting conduit 10 is smaller than that of the shorter connecting conduit 10.

Finally, the plate 53 is fixed to the plate 51 by means of a plurality of screws 56 engaging respective holes 57 parallel to axis B, obtained in the plates 51 and 53 themselves.

The operation of the apparatus 1 is described for the sake of simplicity with reference to a single solenoid valve 3 and to a single ejection head 7; it is apparent that the description applies to all the solenoid valves 3 and all the other ejection heads 7 in identical manner.

When the windings 36 are not energized, the elastic means 31 maintain the interception elements 27 in the closed configuration of the respective conveying channels 5; more specifically, in such a configuration, the shutter 28 of each interception element 27 is pressed against the mouth of the respective conveying channel 5.

One or more magnetic fields, the intensities of which are expanded by the core 35, are generated by selectively energizing the winding 36 of one or more electromagnets 38, i.e. by supplying electricity to one or more windings 36; thus an attraction action is carried out on the corresponding interception element(s) 27 which turn/turns on the annular element 32 resting against the respective layer of non-magnetic material present on the axial end(s) 42 of the cylindrical portion(s) 37.

In particular, considering a single conveying channel 5, the actions of the respective interaction portion 33 of the annular element 32 and of the respective energized electromagnet 38 have application points on the corresponding interception element 27 which are spaced apart; thus, such an interception element 27 is subject to two rotation torques about the respective fulcrum F, one generated by the interaction portion 33 of the annular element 32 and the other generated by the winding 36, which, by virtue of the sense of the current crossing the winding 36 itself, have different modules and opposite senses; the result of such torques determines the rotation of the interception element 27 about the fulcrum F against the action of the elastic means 31 clockwise in FIG. 3, left side.

Thus, following the energizing of one or more windings 36, the respective interaction portion(s) 33 of the annular element 32 is/are compressed and the shutter(s) 28 corresponding to the energized winding(s) disengages/disengage the corresponding conveying channel 5. In this manner, the respective conveying channel(s) 5 is/are open and the flow of pressurized fluid entering the inlet orifice 4 flows along the flow channel 102, touching the windings 36 and reaches the corresponding outlet orifice(s) 6.

From here, the pressurized fluid flow crosses the respective connecting conduits 10 and exits through the corresponding firing nozzle(s) 8 acting directly on the products to be selected.

The one or more windings 36 are automatically ventilated also in case of prolonged or frequent energizing. Since the conveying channels 5 and the outlet orifices 6 are offset with respect to the inlet orifice 4, the flow of pressurized fluid creates a vortex which makes the ventilation of the windings 36 particularly effective, so that their temperature always remains close to the temperature of the pressurized fluid itself. When the energizing of a winding 36 ceases, the pressurized fluid on one side and the elastic bias of the annular element 32 on the other contribute to detaching the respective interception element 27 from the core 35 rapidly closing the corresponding conveying channel 5 without the assistance of additional elements or recalling forces.

By virtue of the fact that the connecting conduits are directly obtained in the covers 50 of the solenoid valves 3, also defining the firing nozzles 8 in turn, the time elapsing between the instant in which the winding 36 is energized and the instant in which the jet of pressurized fluid starts exiting from the respective firing nozzle 8 is minimized; in practice, the apparatus 1 can provide responses substantially in real time to the commands of the actuator assembly 19.

Finally, in order to minimize the dimensions of the apparatus 1 and the center distance between the firing nozzles 8, all aligned along a same plane, the outlet orifices 6 annularly extend about axis A as the respective conveying channels 5; consequently, the length of the connecting conduits 10 must be mutually different. The response times of the system are identical for all firing nozzles 8 by virtue of the fact that the connecting conduits 10 are isovolumetric, i.e. made so as to define the same volume between the outlet orifices 6 and the respective firing nozzles 8.

Thus, the described and illustrated solution allows to minimize the dimensions of the apparatus 1 and the center distance of the firing nozzles 8, but also to obtain response times of the firing nozzles 8 themselves which are particularly short and mutually identical.

It is also worth noting that the described solution allows to minimize the pneumatic connections with consequent minimization of fluid leakage risks.

Finally, the risk of breakages and contamination of the parts during assembly and/or maintenance operations is also minimized.

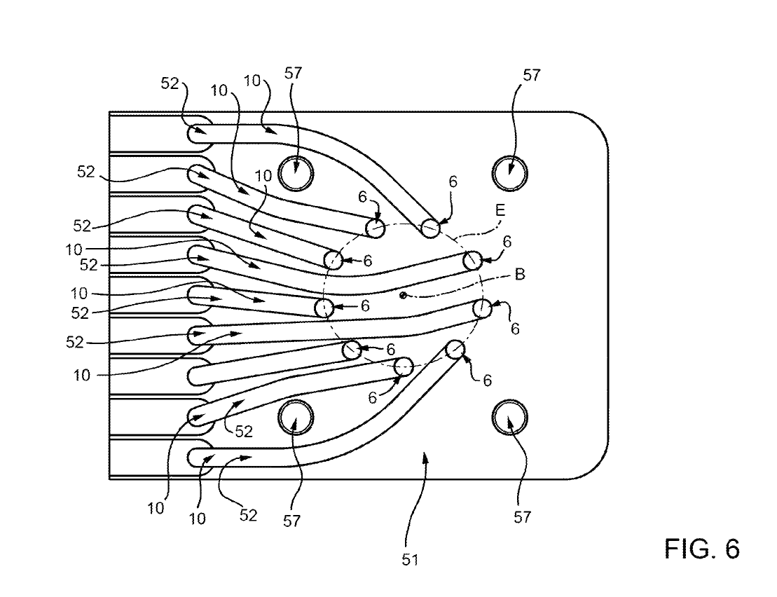

The variant in FIG. 6 shows a possible different arrangement of the outlet orifices 6 of the plate 51 of the lid 50 of the solenoid valves 3. In particular, in this case the outlet orifices 6 of each solenoid valve 3 are arranged along an ellipse E extending about axis B instead of about the circumference C. A similar arrangement may also be adopted by the conveying channels 5.

A smaller distance or pitch between the firing nozzles 8 than that which could be obtained by arranging them along the circumference C and positioning the outlet orifices 6 so that the smaller axis of the ellipse E is parallel to the side of the plate 51 along which the firing nozzles 8 themselves extend.

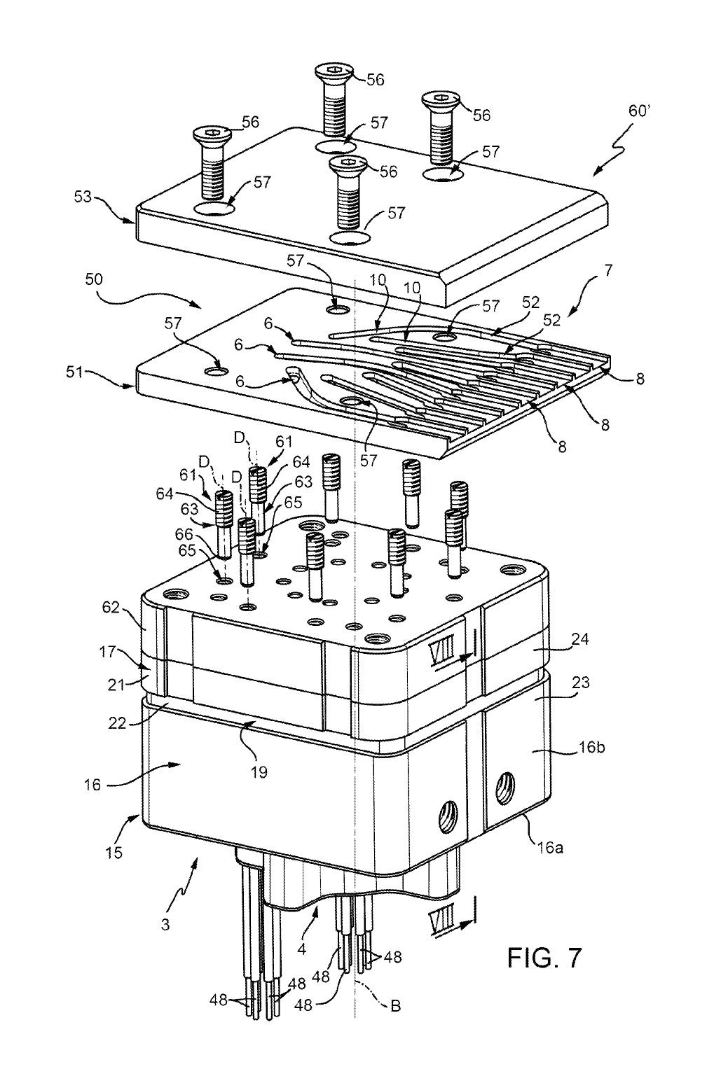

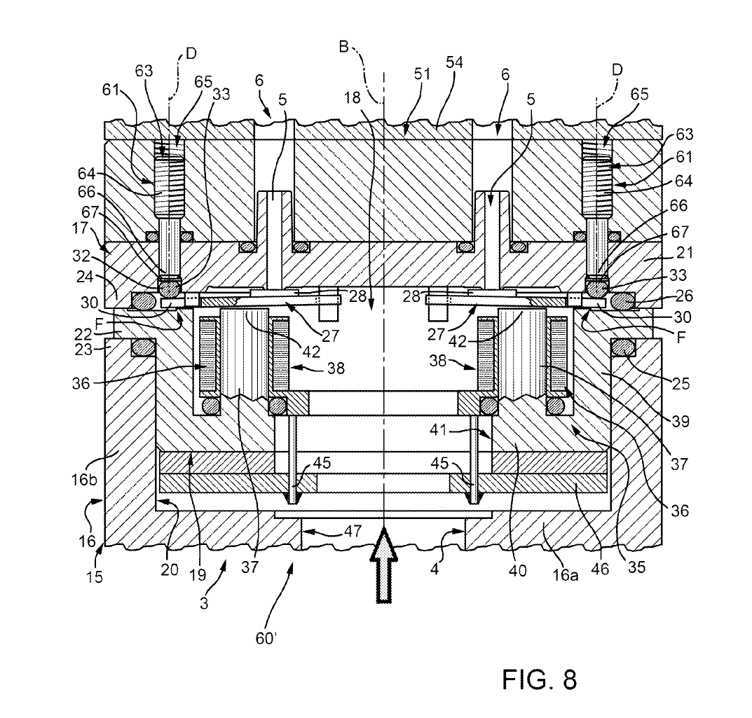

FIGS. 7 and 8 show a possible variant of an operating unit of the apparatus 1, indicated by reference numeral 60′ as a whole, only the differences of such an operating unit 60′ with respect to operating unit 60 will be described hereinafter using the same reference numerals for parts equal or corresponding to those previously described.

In particular, the operating unit 60′ differs from the operating unit 60 substantially in that it comprises a solenoid valve 3′ provided with additional pre-load generating means 61 for pre-loading the annular element 32 at each interception portion 33, with respect to the solenoid valves 3.

More in detail, in this case, the solenoid valve 3′ comprises a further plate 62 fixed in superimposed position and aligned with the plate 21 and carrying the aforesaid pre-load generating means 61.

In practice, the pre-load which is exerted on the various interception portions 33 of the annular element 32 defines the time law with which the corresponding interception elements 27 move from the open configuration to the closed configuration once the action of the actuating group 19 ceases. The pre-load generating means 61 exert their action on different interaction portions 33 of the annular element 32 on the side opposite to the one on which such interaction portions 33 come into contact with the respective interception elements 27.

Advantageously, for each interception element 27, the pre-load generating means 61 comprise a load element 63, which exerts a pressure action on the respective interception portion 33 of the annular element 32 along a predefined axis D, in the illustrated case in point parallel to axis B and to the axis of the respective conveying channel 5, and is coupled to the body 15 so as to be able to vary its position along the axis D itself.

In greater detail, each load element 63 consists of a screw 64, preferably of the flush-mounted type, screwed into a respective threaded hole 65 of axis D obtained through the plates 21 and 62 of the body 15.

As shown in FIG. 8, the holes 65 are arranged by the side of the respective conveying channels 5 which, in this case, are obtained through both plates 21 and 62; furthermore, the number of the holes 65 are equal to the conveying channels 5 and extend in angularly spaced portions along a circumference of axis B.

Each load element 63 and the respective conveying channel 5 extend parallel to each other from a same side of the corresponding interception element 27.

The assembly of each screw 64 in the respective hole 65 or its greater or less screwing into the hole 65 itself to vary its position along the respective axis D may occur after having removed the cover 50.

The screws 64 have respective ends 66 acting on respective interaction portions 33 of the annular element 32 by means of the interposition of an annular foil 67, which works as a spacer to prevent the punctiform contact between the screws 64 and the annular element 32 itself.

The foil 67 has the same diameter as the annular element 32 and is arranged between the latter and the ends 66 of the screws 64.

By fastening or loosening each screw 64 in its hole 65, it is possible to adjust the pre-load of the respective interaction portion 33 of the annular element 32 independently from the other interaction portions 33 of the annular element 32 itself, so as to make the closing times of the interception elements 27 more uniform. Furthermore, by using the screws 64, it is possible to adjust the load by continuously acting on each interaction portion 33 of the annular element 32, i.e. seamlessly, from one adjustment level to the adjacent ones.

The described and illustrated solution of the pre-load adjustment system of the elastic means 31 allows to uniform the response times with the various interception elements 27 associated to a same firing nozzle 8 and to thus ensure a high accuracy of the supplied dynamic low rate values over time.

Furthermore, the adopted pre-load adjustment solution allows to increase the average duration of the operating unit 60′; indeed, if the adjustments established in the past become unsuitable due to wear, if it possible to re-time the closing times of the conveying channels 5 by acting on the respective screws instead of a complete replacement of the operating unit 60′ itself.

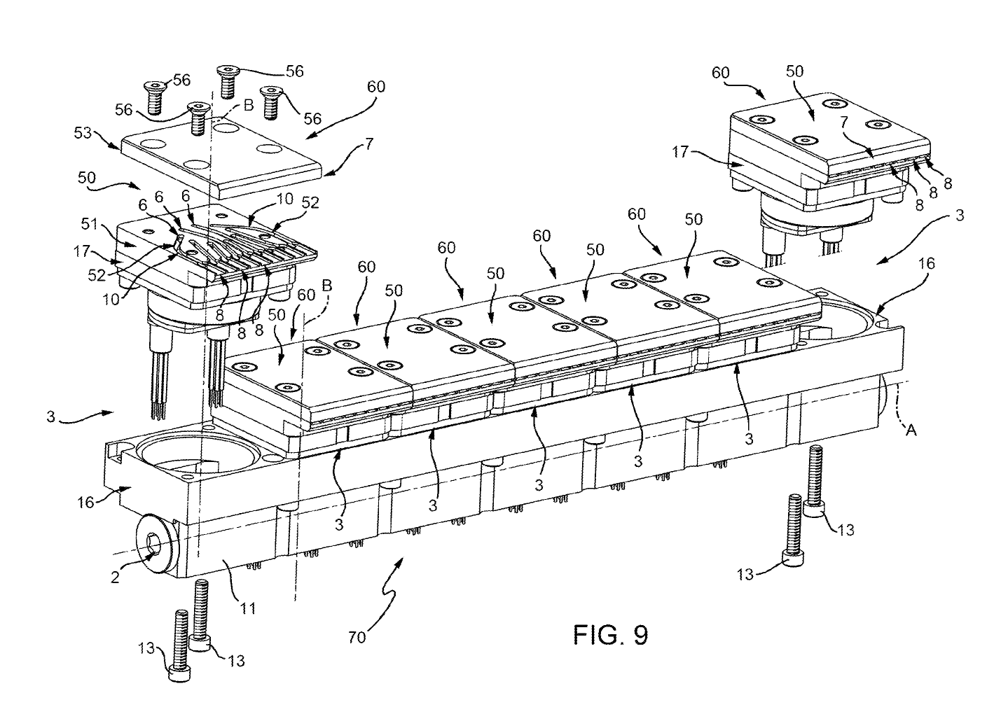

With reference to FIG. 9, reference numeral 70 shows as a whole a different embodiment of a pneumatic product sorting apparatus made according to the present invention; only the differences of apparatus 70 with respect to apparatus 1 will be described hereinafter using the same reference numerals for parts equal to or corresponding to those previously described.

In particular, the apparatus 70 differs from the apparatus 1 substantially in that the base bar 11 entirely defines part of the bodies 15 of the solenoid valves 3, 3′.

More specifically, the structures 16 are obtained integrally with the bar 11 and protrude cantilevered therefrom.

It is finally apparent that changes and variations can be implemented to the apparatuses 1, 70 herein described and illustrated without departing from the scope of protection of the claims.

In particular, the body 15 of the solenoid valves 3, 3′ may have an approximately cylindrical inner and/or outer section.

Furthermore, the firing nozzles 8 could extend in parallel to axis B, to the inlet orifice 4, to the outlet orifices 5 and to the conveying channels 5.

1. A pneumatic product sorting apparatus (1, 70) comprising:
at least a solenoid valve (3, 3′) having a hollow body (15) defining at least one inlet orifice (4) for a pressurized fluid, a plurality of outlet orifices (6) for said fluid, and a plurality of conveying channels (5) for conveying said fluid from said inlet orifice (4) to respective said outlet orifices (6), said solenoid valve (3, 3′) also comprising, for each said conveying channel (5), an interception element (27) housed inside said body (15) and selectively movable between a closed configuration, in which it interferes with the respective said conveying channel (5) preventing said fluid from passing through it, and an open configuration, in which it leaves free the respective said conveying channel (5) allowing said fluid to pass through it;
at least one ejection head (7) having a plurality of firing nozzles (8) that is selectively activated for emitting respective pressurized fluid jets directly on products to be selected; and
a plurality of connecting conduits (10) connecting each firing nozzle (8) with a corresponding outlet orifice (6) of said solenoid valve (3, 3′, 3′);
wherein said ejection head (7) is formed by a cover (50) of the body (15) of said solenoid valve (3, 3′),
characterized in that said connecting conduits (10) are formed in said cover (50) and in that at least two of said connecting conduits (10) have different lengths and identical volumes from said outlet orifices (6) of said solenoid valve (3, 3′) to the respective firing nozzles (8).

2. The apparatus according to claim 1, wherein the cross section of the longest of said two connecting conduits (10) of different lengths is smaller than that of the shorter connecting conduit (10) of said two connecting conduits (10) of different lengths.

3. (canceled)

4. The apparatus according to claim 1, wherein said body (15) has a main axis (B), and wherein said inlet orifice (4), said outlet orifices (6) and said conveying channels (5) extend parallel to said main axis (B).

5. The apparatus according to claim 1, wherein said outlet orifices (6) of said solenoid valve (3, 3′) are formed in said cover (50).

6. The apparatus according to claim 1, wherein said firing nozzles (8) are formed on a side surface of said cover (50), and wherein said connecting conduits (10) extend transversely to said conveying channels (5) and to said outlet orifices (6).

7. The apparatus according to claim 1, wherein said connecting conduits (10) are constituted by holes formed in said cover (50) and connecting said outlet orifices (6) of said solenoid valve (3, 3′) to respective said firing nozzles (8).

8. The apparatus according to claim 4, wherein said outlet orifices (6) extend around said main axis (B) of said body (15).

9. The apparatus according to claim 8, wherein said outlet orifices (6) of said solenoid valve (3, 3′) are equally spaced angularly about said main axis (B) of the body (15) of the solenoid valve (3, 3′) itself.

10. The apparatus according to claim 8, wherein said outlet orifices (6) of said solenoid valve (3, 3′) are arranged along an ellipse (E) extending around said main axis (B) of the body (15) of the solenoid valve (3, 3′) itself.

11. The apparatus according to claim 1, wherein said cover (50) comprises:
a first plate (51) supporting said outlet orifices (6) and said firing nozzles (8) and provided with a plurality of grooves (52) connecting said outlet orifices (6) to said firing nozzles (8); and
a second plate (53) fixed in position superimposed on said first plate (51) and delimiting with said grooves (52) said connecting conduits (10).

12. The apparatus according to claim 11, wherein said grooves (52) are formed in said first plate (51) by way of milling.

13. The apparatus according to claim 1, wherein said solenoid valve (3, 3′) further comprises:
elastic means (31) acting on said interception elements (27) to place them in said closed configuration; and
actuator means (19) carried by said body (15) and selectively operable to move each said interception element (27) in said open configuration against the action of said elastic means (31).

14. The apparatus according to claim 13, wherein said solenoid valve (3′) further comprises pre-load generator means (61) carried by said body (15) to generate a pre-load on said elastic means (31) defining the time law with which each said interception element (27) moves from said open configuration to said closed configuration once the action of said actuator means (19) ceases.

15. The apparatus according to claim 14, wherein said elastic means (31) comprise an annular elastically yieldable element (32) having a plurality of interaction portions (33) acting on contact portions (30) of respective said interception elements (27), and wherein said pre-load generator means (61) comprise, for each said interception element (27), a load element (63), which exerts a pressure action on relative said interaction portion (33) of said elastically yielding element (32) along a predefined adjustment axis (D), and is coupled to said body (15) so as to be able to vary its own position along said adjustment axis (D).

16. The apparatus according to claim 15, wherein each said adjustment axis (D) is parallel to a main axis (B) of said body (15).

17. The apparatus according to claim 1, further comprising a common supplying manifold (2) of said solenoid valves (3, 3′) with said pressurized fluid, said manifold (2) being formed in a base element (11) supporting in cantilever manner said solenoid valves (3, 3′).

18. The apparatus according to claim 15, wherein said base element (11) integrally defines at least part of the bodies (15) of said solenoid valves (3, 3′).

19-21. (canceled)
